(19) United States
(12) Patent Application Publication
(10) Pub. No.: US 2006/0127625 A1
(43) Pub. Date: Jun. 15, 2006

(54) Heat-sealing adhesive film

(75) Inventor: Wen-Chang Lu, Taipei Hsien (TW)

Correspondence Address: WEN-CHANG LU, 9F., No.37, Dongsing Road, Xinyi District, Taipei City, 110, TW

(73) Assignee: TAIWAN HIPSTER ENTERPRISE CO., LTD

(21) Appl. No.: 11/010,071

(22) Filed: Dec. 13, 2004

(51) Int. Cl. B32B 33/00

(52) U.S. Cl. 428/40.1; 428/347

(57) ABSTRACT

A heat-sealing adhesive film includes a thin film of high melting point heat-sealing adhesive layer having two low melting point heat-sealing adhesive layers separately applied over two opposite sides thereof. When the heat-sealing adhesive film is heated to a specific temperature suitable for melting the two low melting point heat-sealing adhesive layers but lower than the melting temperature of the high melting point heat-sealing adhesive layer, the two low melting point heat-sealing adhesive layers becoming cured provide an excellent bonding strength between them and a substrate and a surface item separately pressed against two sides of the heat-sealing adhesive film, and the high melting point heat-sealing adhesive layer enables the two low melting point heat-sealing adhesive layers to firmly, elastically, and flexibly bond to each other.

### FIELD OF THE INVENTION

The present invention relates to a heat-sealing adhesive film, and more particularly to a heat-sealing adhesive film that can be easily processed to provide firm, elastic, and flexible bonding between two items.

### BACKGROUND OF THE INVENTION

FIG. 1 shows a conventional heat-sealing adhesive film consisting of a heat-sealing adhesive layer 7 and a release paper 70 removably attached to at least one side of the layer 7 for isolating and protecting one surface of the layer 7 from external environment to facilitate storage and transportation of the heat-sealing adhesive film before the same is processed for use. FIGS. 2 and 3 shows steps of processing the heat-sealing adhesive film of FIG. 1. As shown, to use the heat-sealing adhesive layer 7, first attach a bare-side of the layer 7, that is, the side of the layer 7 without the release paper 70 (or tear off the release paper 70 if there is one), to a substrate item 5, and keep the other side of the layer 7 protected by the release paper 70. Then, heat and press the layer 7 against the substrate item 5 using a heating compression mold 6 heated to a suitable temperature, so that the layer 7 is firmly bonded to the substrate item 5 by way of heat sealing. The release paper 70 avoids the heated layer 7 from adhering to the compression mold 6. Thereafter, remove the release paper 70 from the layer 7 to bare the other side thereof, and attach a surface item 50 to the bared surface of the layer 7, and then press the surface item 50 against the layer 7 and the substrate item 5 using the compression mold 6 heated to a suitable temperature, so that the substrate item 5 and the surface item 50 are bonded together via the heat-sealing adhesive layer 7.

The following disadvantages are found in using the conventional heat-sealing adhesive film having only one heat-sealing adhesive layer 7 to bond the substrate item 5 to the surface item 50:
1. The conventional heat-sealing adhesive layer 7 has a bonding property that varies with the heating temperature of the layer 7. When it is processed with higher temperature and pressure, the layer 7 shows better bonding strength but is harder and less flexible after becoming cooled, and is therefore not suitable for bonding substrate and surface items 5, 50 that are relatively elastic and flexible. Reversely, the layer 7 processed with lower temperature and pressure shows better elasticity and flexibility but lower bonding strength after becoming cooled, and is therefore easily separated from the items bonded thereto through heat sealing.
2. The volume of the heat-sealing adhesive layer 7 for bonding the substrate item 5 to the surface item 50 also varies with the properties of the items 5 and 50. For example, spilt adhesive occurs to spoil the quality of a bonded product when an excessive volume of heat-sealing adhesive layer 7 is used, pressurized, and heated to bond cotton fabrics.

It is therefore tried by the inventor to develop an improved heat-sealing adhesive film to eliminate the drawbacks existed in the conventional heat-sealing adhesive film having only one heat-sealing adhesive layer.

### SUMMARY OF THE INVENTION

A primary object of the present invention is to provide a heat-sealing adhesive film that enables a substrate and a surface item to be firmly, elastically, and flexibly bonded together.

To achieve this object, the heat-sealing adhesive film according to the present invention includes a thin film of high melting point heat-sealing adhesive layer having two low melting point heat-sealing adhesive layers separately applied over two opposite sides thereof with a good bonding strength between the high and the low melting point heat-sealing adhesive layers. When the heat-sealing adhesive film is heated to a specific temperature suitable for melting the two low melting point heat-sealing adhesive layers but lower than the melting temperature of the high melting point heat-sealing adhesive layer, the two low melting point heat-sealing adhesive layers becoming cured provide an excellent bonding strength between them and a substrate and a surface item separately pressed against two sides of the heat-sealing adhesive film, and the high melting point heat-sealing adhesive layer enables the two low melting point heat-sealing adhesive layers to firmly, elastically, and flexibly bond to each other.

Another object of the present invention is to provide a heat-sealing adhesive film that does not spill over even when it is used to bond cotton fabrics and therefore effectively avoids adverse influences on the quality of the bonded products.

To achieve this second object, each of the high and the low melting point heat-sealing adhesive layers forming an integral structure of the heat-sealing adhesive film of the present invention has a thickness smaller than that of the conventional heat-sealing adhesive film formed from only one layer and only one type of adhesive material.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows the structure of a conventional heat-sealing adhesive film;

FIG. 2 shows a first step of processing the conventional heat-sealing adhesive film of FIG. 1 for bonding it to a substrate item;

FIG. 3 shows a second step of processing the conventional heat-sealing adhesive film of FIG. 1 for bonding it to a surface item;

FIG. 4 shows the structure of a heat-sealing adhesive film according to a first embodiment of the present invention;

FIG. 5 shows a first step of processing the heat-sealing adhesive film of FIG. 4 for bonding it to a substrate item;

FIG. 6 shows a second step of processing the heat-sealing adhesive film of FIG. 4 for bonding it to a surface item; and

FIG. 7 shows the structure of a heat-sealing adhesive film according to a second embodiment of the present invention.

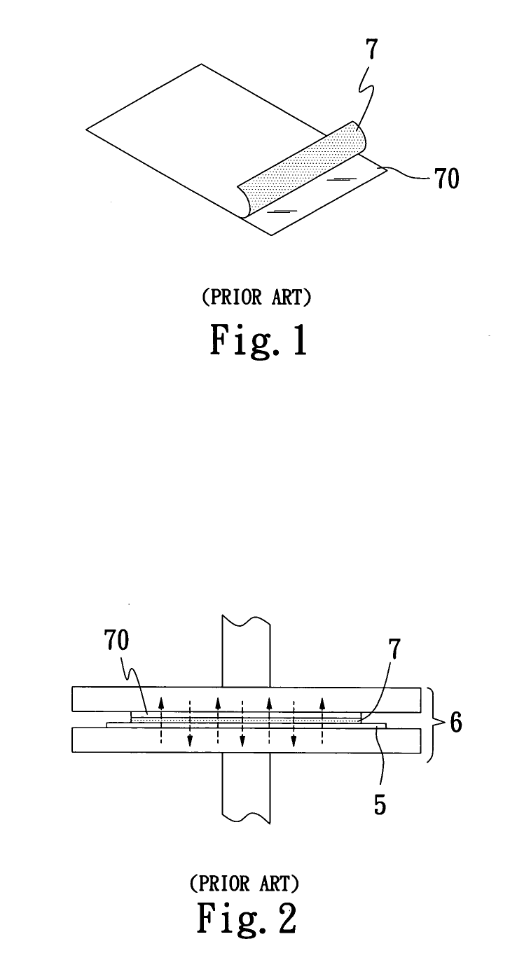

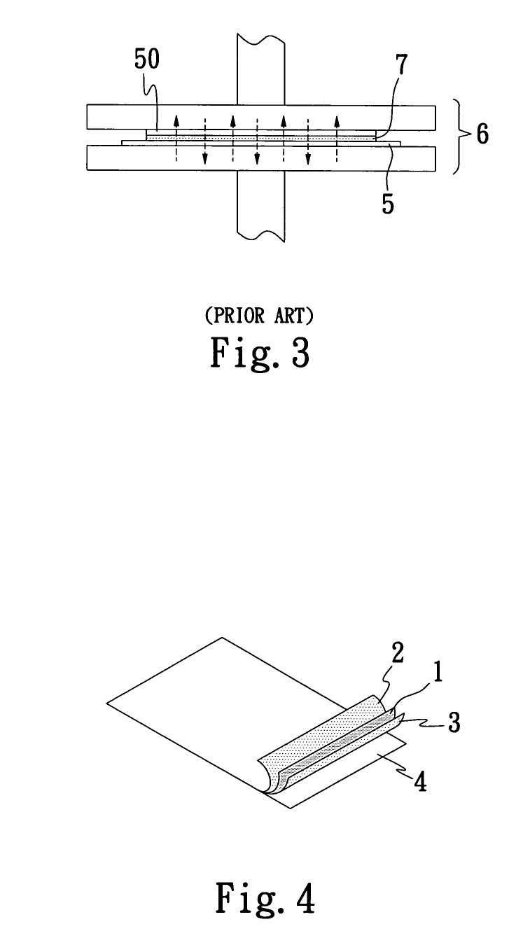

### DETAILED DESCRIPTION OF THE PREFERRED EMBODIMENTS

Please refer to FIG. 4 in which a heat-sealing adhesive film according to a first embodiment of the present invention is shown. As shown, the heat-sealing adhesive film mainly includes a high melting point heat-sealing adhesive layer 1, a first and a second low melting point heat-sealing adhesive layer 2 & 3, respectively, and a release paper 4. The high melting point heat-sealing adhesive layer 1 is a thin film of polyurethane (PU) or thermoplastic polyurethane (TPU) that has a relatively high melting temperature. The first and the second low melting point heat-sealing adhesive layer 2, 3 are made of a material providing excellent bonding strength between them and the high melting point heat-sealing adhesive layer 1 for separately applied over two opposite sides of the high melting point heat-sealing adhesive layer 1, and have melting points lower than that of the layer 1. The release paper 4 is removably attached to an outer surface of at least one of the two low melting point heat-sealing adhesive layers 2, 3 to protect the latter. In the illustrated embodiment of FIG. 4, the release paper 4 is attached to the outer surface of the second low melting point heat-sealing adhesive layer 3. The release paper 4 also facilitates convenient isolation, protection, storage, and transportation of the heat-sealing adhesive film before any processing thereof.

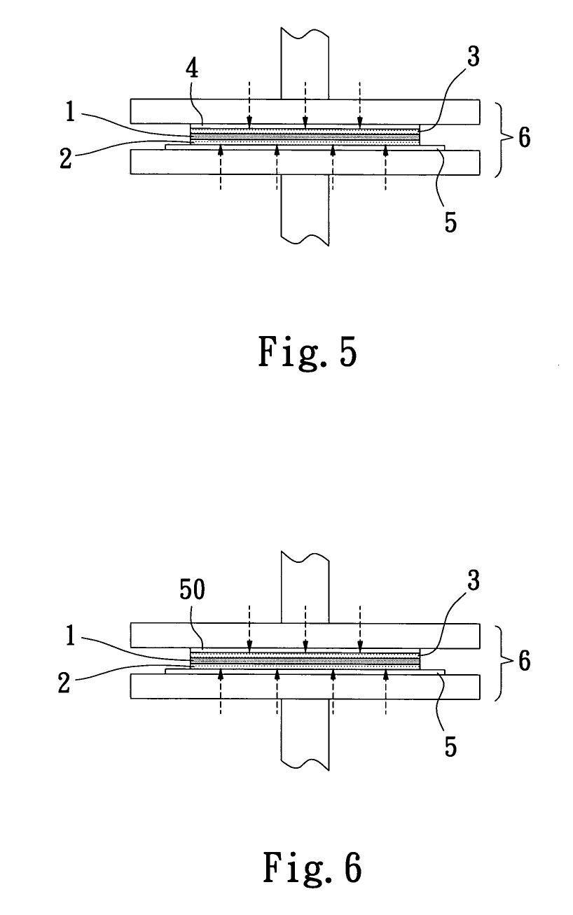

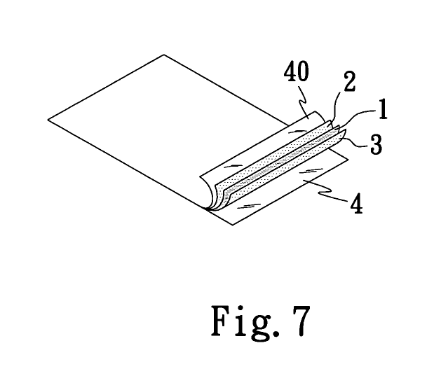

To use the heat-sealing adhesive film for heat-sealing two items together, first attach the low melting point heat-sealing layer without the release paper 4 (it is the first low melting point heat-sealing layer 2 in the illustrated drawing) to a substrate item 5, as shown in FIG. 5. Then, heat and press the heat-sealing adhesive film and the substrate item 5 against each other using a heating compression mold 6 heated to a temperature suitable for melting the first and the second low melting point heat-sealing adhesive layers 2, 3 but lower than the melting point of the high melting point heat-sealing adhesive layer 1, so that the first low melting point heat-sealing adhesive layer 2 is caused to firmly bond to the substrate item 5. Thereafter, remove the release paper 4 and attach a surface item 50 to the second low melting point heat-sealing adhesive layer 3, and heat and press the heat-sealing adhesive film, the substrate item 5, and the surface item 50 against one another using the heating compression mold 6 heated to the same temperature as in the previous step, so that the surface item 50 is firmly bonded to the second low melting point heat-sealing adhesive layer 3, as shown in FIG. 6.

It is noted the heat-sealing adhesive film of the present invention having been heated at a specific temperature suitable for melting the two low melting point heat-sealing adhesive layers 2, 3 but lower than the melting temperature of the high melting point heat-sealing adhesive layer 1 would have cured layers 2, 3 that provide an improved bonding strength with the substrate and the surface item 5, 50, respectively, and a relatively flexible high melting point heat-sealing adhesive layer 1 enabling the substrate item 5 to be firmly, elastically, and flexibly bonded to the surface item 50.

FIG. 7 shows a heat-sealing adhesive film according to a second embodiment of the present invention. The second embodiment is structurally similar to the first embodiment, except that two sheets of release papers 40, 4 are separately attached to outer surfaces of the first and the second low melting point heat-sealing adhesive layer 2, 3 to provide even better protection of the heat-sealing adhesive film against possible damages before and during processing thereof.

What is claimed is:

1. A heat-sealing adhesive film, comprising a thin film of high melting point heat-sealing adhesive layer, two low melting point heat-sealing adhesive layers separately applied over two opposite sides of said high melting point heat-sealing adhesive layer and having a melting point lower than that of said high melting point heat-sealing adhesive layer, and a release paper removably attached to an outer surface of at least one of said two low melting point heat-sealing adhesive layers.

2. The heat-sealing adhesive film as claimed in claim 1, wherein both said two low melting point heat-sealing adhesive layers have one said release paper attached to an outer surface thereof.

3. The heat-sealing adhesive film as claimed in claim 1, wherein said high melting point heat-sealing adhesive layer is made of a thermoplastic polyurethane (TPU) material.

4. The heat-sealing adhesive film as claimed in claim 2, wherein said high melting point heat-sealing adhesive layer is made of a thermoplastic polyurethane (TPU) material.

5. The heat-sealing adhesive film as claimed in claim 1, wherein said high melting point heat-sealing adhesive layer is made of a polyurethane (PU) material.

6. The heat-sealing adhesive film as claimed in claim 2, wherein said high melting point heat-sealing adhesive layer is made of a polyurethane (PU) material.
